(19) United States
(12) Patent Application Publication
(10) Pub. No.: US 2007/0220492 A1
(43) Pub. Date: Sep. 20, 2007

(54) Application verifier infrastructure and checks

(75) Inventors: Ivan Brugiolo, Bellevue, WA (US); Silviu C. Calinoiu, Kirkland, WA (US); Feng Min, Kirkland, WA (US); Jennifer L. Norberg, Woodinville, WA (US); Donald J. Munsil, Kirkland, WA (US); Raymond D. Parsons, Redmond, WA (US); Ayesha Mascarenhas, Seattle, WA (US); William H. Shihara, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/377,066

(22) Filed: Mar. 16, 2006

(51) Int. Cl. G06F 9/44

(52) U.S. Cl. 717/126; 717/127

(57) ABSTRACT

A verifier infrastructure for a runtime verification tool is provided. The verifier infrastructure includes a managing module and one or more verifier modules. The verifier modules provide the verification for checks (tests) to predict how well an application will perform under a certain runtime setting. Each verifier module is configured to be plugged into the runtime verification tool in a standardized way. The managing module manages the verifier modules by transmitting runtime settings to the verifier modules and collecting information regarding testing of an application from the verifier modules. The collected information is reported back to users for detecting and/or debugging runtime errors.

### BACKGROUND

Some software programming code errors can be difficult to identify with normal application testing. Generally described, an application verification tool is a software program that provides verification of the execution of programming code. In a typical application verification tool, the tool is configured to conduct a series of tests to detect and/or help to debug various common programming mistakes (errors) related to memory corruptions, hangs, handle usage, and other critical vulnerabilities. Based on the outcome of the series of tests, the errors can be identified to a user.

In a typical embodiment, an application verification tool includes an engine for monitoring the execution of a tested software application. The engine monitors the application's behavior by intercepting Application Programming Interface (API) calls. An application verification tool further includes an IAT replacement engine for providing processing the intercepted API calls. More specifically, in one embodiment, the IAT replacement engine enables specially written software modules located in dynamic link libraries (DLLs), generally referred to as API shims, to be inserted between an application and the operating system. The API shim DLLs intercept standard API calls to the modules of the operating system and facilitate the execution of the series of tests. The current approach to using a separate IAT replacement engine with extra configuration requirement can limit the flexibility of the application verification tool. In one aspect, the shim DLLs are typically statically created and managed. Additionally, each API shim DLL is tightly coupled with a corresponding verification procedure. This static nature of the IAT replacement engine prevents the application verification tool from being easily integrated into various computing environments other than the environment in which the API shims were created for. Further, current application verification tool approaches do not typically provide a standardized infrastructure for allowing additional tests (checks) to be integrated into the tool. Such lacking of the standardized infrastructure severely limits the scalability of the application verification tool.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A verifier infrastructure for a runtime verification tool is provided. The verifier infrastructure includes a managing module and one or more verifier modules. The verifier modules provide the verification for checks (tests) to predict how well an application will perform under a certain runtime setting. Each verifier module is configured to be plugged into the runtime verification tool in a standardized way. The managing module manages the verifier modules by transmitting runtime settings to the verifier modules and collecting information regarding testing of an application from the verifier modules. The collected information is reported back to users for detecting and/or debugging runtime errors.

In accordance with an aspect of the invention, a method for collecting information regarding execution of an application is provided. A computing device obtains verifier information from at least one verifier layer. The computing device then advertises a descriptor of the verifier layer to the user. The computing device obtains runtime settings associated with the execution of a software application on a computer system. The computing device transmits the runtime settings to the verifier layer. The communication between the verifier layer and the computing device is normalized and structured in such a way that the knowledge of how settings are stored and applied is not specific to the implementation of the verification layer.

The computing device further collects verification events information from the verifier layer. The computing device then processes the collected verification events information and reinterprets the processed information. In one embodiment, the computing device may provide a log of information to users. The runtime settings may be used to ensure that the application does not hide access violation by use of exception handling, to verify that the application properly manages virtual memory space, or to track unsafe use of API.

In accordance with another aspect of the invention, a method for providing information regarding execution of an application is provided. A computing device transmits verification information to a managing module. The computing device obtains a runtime setting and then evaluates the obtained runtime setting. Upon evaluation, the computing device updates verification code based on the runtime setting. This allows the verification code to be enabled or disabled based on the runtime setting. While the application is running, the enabled verification code will be executed. The computing device collects execution tracing information (which may be processed and converted in log entries or in debugger events, according to the user choice and preference) regarding the execution of the enabled verification code. Then, the computing device provides normalized execution tracing information to the managing module.

In accordance with yet another aspect of the invention, a computer-readable medium having computer-executable components for implementing runtime verification of an application is provided. The computer-readable medium includes verifier layer components that provide verification code. The computer-readable medium further includes a core module component that manages the verifier layer components. The core module component passes runtime settings to the verifier layer components. The verifier layer components dynamically evaluate the received runtime settings to determine whether to execute verification code associated with the verifier layer components. The core module component causes the application to continue to run after the verifier layer components have dynamically evaluated the runtime setting. The core module component collects verification events information from the verifier layer components and then processes the verification events information. The core module component transmits the verification events information to help users to detect and/or debug runtime errors.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a computer system implementing runtime verification tool utilizing an exemplary verifier infrastructure in accordance with an embodiment of the present invention;

FIGS. 2A and 2B are block diagrams of the system of FIG. 1 illustrating interactions among software components of the system in accordance with an embodiment of the present invention;

FIG. 3 is a block diagram of the system of FIG. 1 illustrating a core module including a runtime setting module and a log/report module, and other modules in accordance with an embodiment of the present invention;

FIG. 4 is a block diagram of an exemplary verifier provider in accordance with an embodiment of the present invention;

FIGS. 5A and 5B are block diagrams of the system of FIG. 1 illustrating the verifier layer components associated with an application in accordance with an embodiment of the present invention;

FIG. 6 is a flow diagram of a verification routine utilizing a verifier infrastructure in accordance with an embodiment of the present invention; and

FIG. 7 is a flow diagram of a runtime setting evaluation routine utilizing a verifier infrastructure in accordance with an embodiment of the present invention.

### DETAILED DESCRIPTION

Generally described, the present invention relates to a system and method for providing runtime verification utilizing a flexible and scalable verifier infrastructure. More specifically, the present invention relates to verifier modules utilized in conjunction with a verifier managing module for providing a flexible and scalable verifier infrastructure. Although the present invention will be described with relation to illustrative embodiments utilizing an illustrative verifier infrastructure and verifier modules, one skilled in the relevant art will appreciate that the disclosed embodiments are illustrative in nature and should not be construed as limiting.

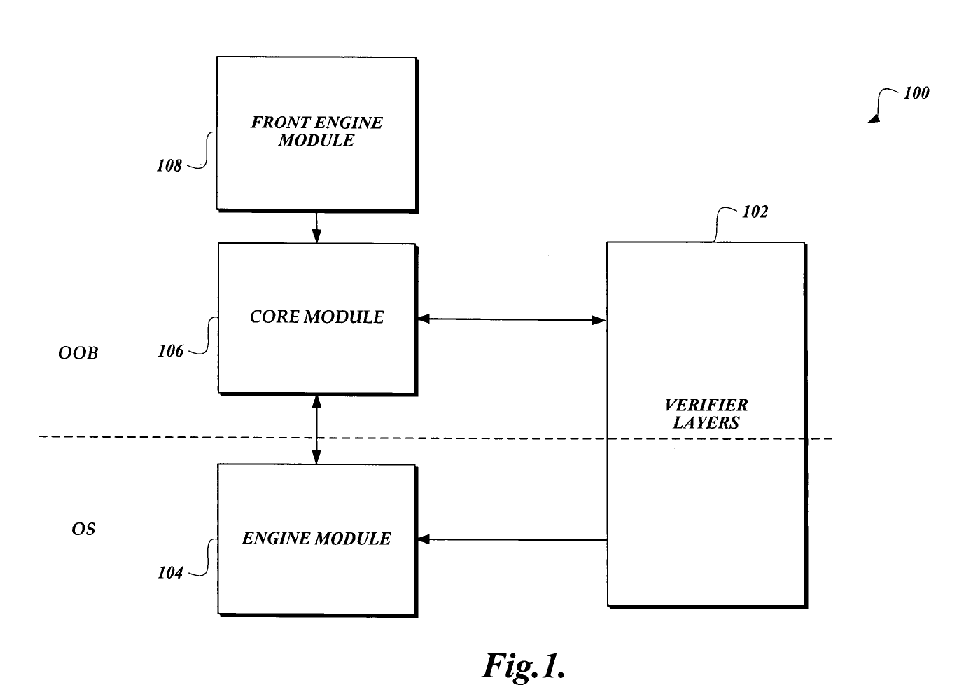

FIG. 1 is a block diagram illustrative of various components associated with a computer system 100 for implementing runtime verification utilizing an exemplary verifier infrastructure. As will be described in greater detail below, the computer system 100 includes verifier layers 102, an engine module 104, and a core module 106. The engine module 104 is configured to deploy the core module 106 and the verifier layers 102. The engine module 104 further performs API hooking (e.g., API intercepting). One of ordinary skill in the art will understand that API hooking can include the redirection of a tested API call intercepted for the operating system to a desired replacement function. Generally, this replacement function performs some manipulation or other processing of the input parameters before transferring control back to the called API. Additionally, in an illustrative embodiment, the replacement function may be used to manipulate the API's return results before passing the return results back to the caller of the API. As will be appreciated by one of ordinary skill in the art, there are various methods to implement API hooking in a computing environment. In an illustrative embodiment, API hooking utilizes Import Address Table (IAT) modification.

With continued reference to FIG. 1, the core module 106 is configured to provide a test command to verifier layers 102 in order to perform a desired test. For example, the core module 106 passes runtime setting as a test command to verifier layers 102 after receiving the runtime settings from the engine module 104. Such runtime settings (runtime parameter settings) may be used to change behaviors of APIs called by the runtime application. The verifier layers 102 perform the verification for checks (tests) to predict how well an application will perform under a certain runtime setting. It is to be noted that the runtime setting is described here as an example of a test command. It is contemplated that the core module 106 is configured to pass any suitable test command to cause a verifier layer to execute desired verification code. Some verifier layers may be operating system native, while other verifier layers may be developed using a normalized interface for advertising the verifier information relating to the verifier layers, including a set of configurable properties (e.g., runtime configurable properties, static configurable properties, and the like), a set of interfaces, and a set of verification events among others.

The computer system 100 further includes a front engine module 108 that allows users to specify an application to be verified and to select the desired testing for the application. Based on the user selection for the desired testing, a loader in conjunction with the engine module 104, loads the core module 106 and several verifier layers 102 corresponding to the desired testing. Generally described, a loader, a part of the operating system, is automatically invoked when a processor is run. The loader typically loads the executable code of a program into memory for execution. In one embodiment, the core module and the verifier layers are loaded earlier than any other executable code. In this embodiment, the verifier layers 102 can be suitable for verifying checks such as security checks, list of user accounts (LUA), or the like. As described above, the engine module 104 deploys the core module 106 and the verifier layers 102 after the core module 106 and the verifier layers 102 have been loaded into memory. The verifier layers 102 include a simple protocol to declare to the engine module 104 and the core module 106 what interfaces are verified at the time of deployment. After the core module 106 and the verifier layers 102 are deployed, the verifier layers 102 register with the core module 106. This registration advertises a set of configurable properties of verification layers, a set of verification events, a set of interfaces to be verified, and the like. The core module 106 may pass runtime settings to the verifier layers 102, based upon the set of advertised configurable properties. Furthermore, the core module 106 may instruct the verifier layers 102 about actions of the verification events. The verification events may cause generation of a log entry and/or a debugger event in accordance with the instruction.

In one embodiment, the front engine module 108 may provide various user interfaces suitable for each user's display device. In an alternative embodiment, the computer system 100 may include an additional user interface module to allow a user to create and/or modify a command line for debugging errors that have been detected by the verifier layers. The command line may include runtime settings which will be used to change behaviors of APIs via the verifier layers.

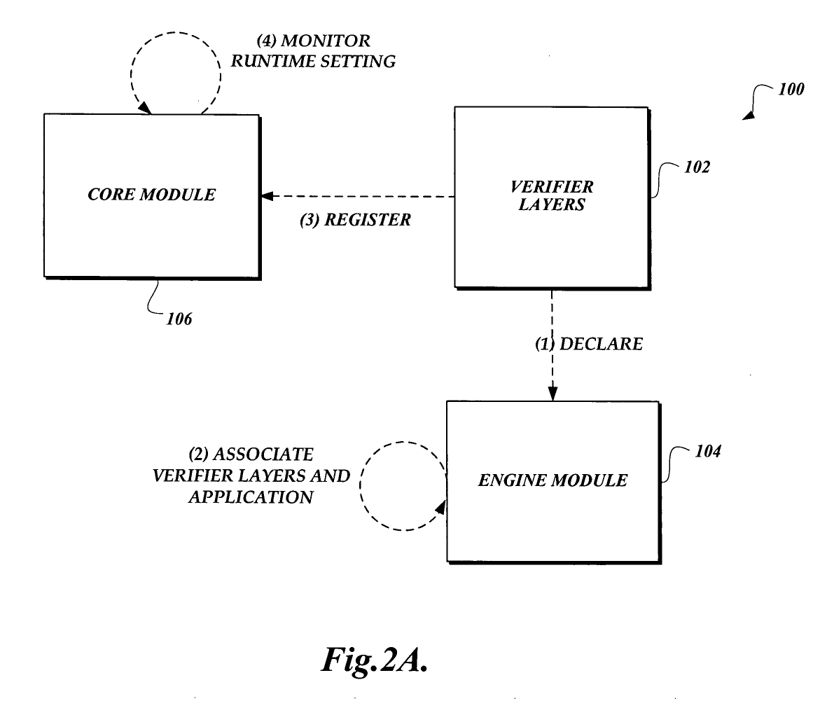

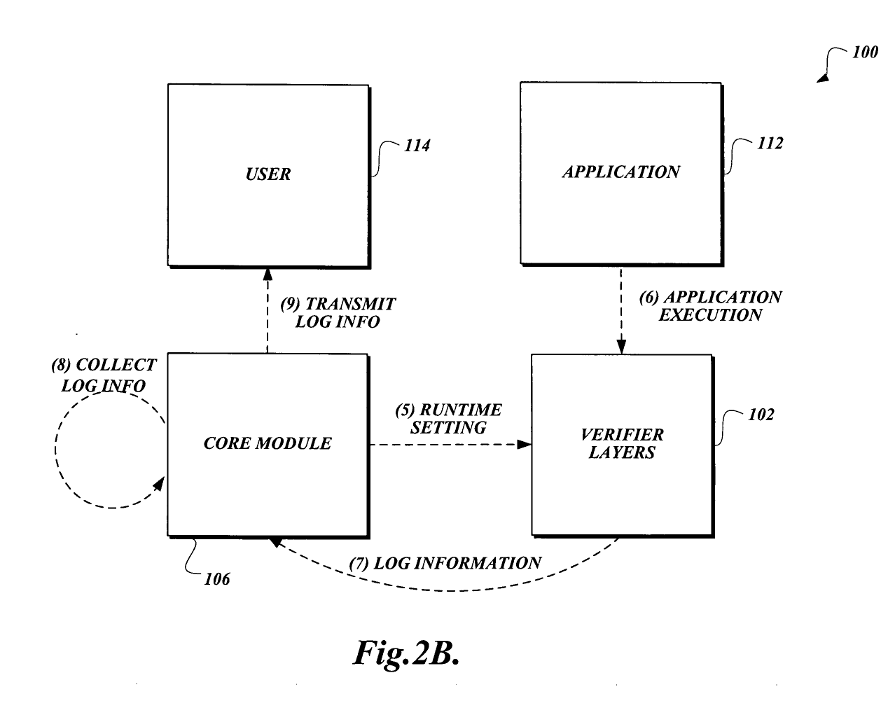

With reference to FIGS. 2A and 2B, block diagrams of the computer system 100 illustrating interactions among software components of the computer system 100 in accordance with an embodiment of the present invention is shown. The engine module 104 is configured to associate the application and the verifier layers 102 to prepare desired API hooking. In one embodiment, the engine module 104 may associate the application with the verifier layers 102 by modifying the IAT of the application so that the IAT is ready for the desired API hooking. For example, when an API is to be intercepted for runtime verification, an entry-point address of the API in the IAT of the application is redirected to replacement functions defined in verification code in a verifier layer.

In an illustrative embodiment, more than one verifier layer may include corresponding verification code which defines replacement functions for a certain API. In such a case, verification code in each verifier layer may form a linked list to redirect the entry point from the verification code in one verifier layer to the verification code in the next verifier layer, thereby redirecting the API to all of the available verification code in the verifier layers. Alternatively, the engine module 104 may inject several verifier layers in a hierarchical order.

As will be described in greater detail, the core module 106 manages the verifier layers 102 and provides various services to the verifier layers 102. Examples of the services provided by the core module 106 include providing instructions for which verification events information is to be collected, logging information provided by the verifier layers 102, processing the log information, and reporting the processed log information to users, among others. Further, the core module 106 provides common facilities which are needed by all verifier layers 102. For example, the core module 106 maintains the global knowledge relating to active verifier layers in the computer system 100. Although each verifier layer does not have information regarding activities of other verifier layers, a verifier layer can receive such information from the core module 106 when it is necessary.

After having been loaded, the verifier layers 102 register with the core module 106 so that runtime settings and instructions are passed along to the verifier layers 102. In an embodiment, the verifier layers 102 register a callback function to the core module 106, which will be called by the core module to pass runtime settings when the core module receives the runtime settings. In this manner, the core module 106 and the verifier layers 102 are loosely coupled and various numbers of verifier layers can be plugged into the verifier infrastructure of the computer system 100 in a standardized way without requiring any code changes in the core module 106.

In an embodiment, runtime setting can be used to change behaviors of certain APIs in order to verify desired tests (checks). Based on the instructions from the core module, each of the verifier layers 102 obtains selective information regarding the behaviors of the API's as the application 112 is running. Each of the verifier layers 102 provides the obtained information to the core module 106. The core module 106 receives verification events information from the verifier layers 102 and then process the verification event information. In one embodiment, the core module 106 generates log information based on the processed verification events information and transmits the log information to users 114. In alternative embodiment, the core module 106 transmits the verification event information to the front engine module 108 which processes the verification event information to produce a desired report for the users 114.

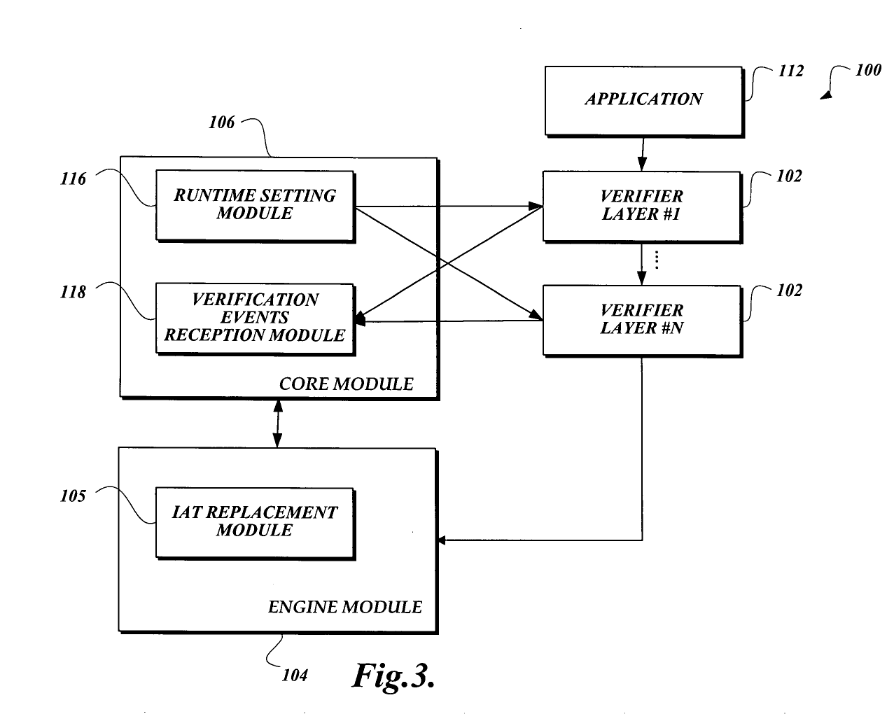

As shown in FIG. 3, in a particular embodiment, the core module 106 may include a runtime setting module 116 and a verification events reception module 118. The runtime setting module 116 provides runtime settings to the verifier layers 102 in a way that the registration information indicates. As mentioned above, the registration information has been obtained from the verifier layers 102. The verification events reception module 118 collects verification events information from the verifier layers 102, processes the event information, and (based upon verification events configuration information) reports the processed events to users 114. The engine module 104 includes an IAT replacement module 105 that performs API hooking.

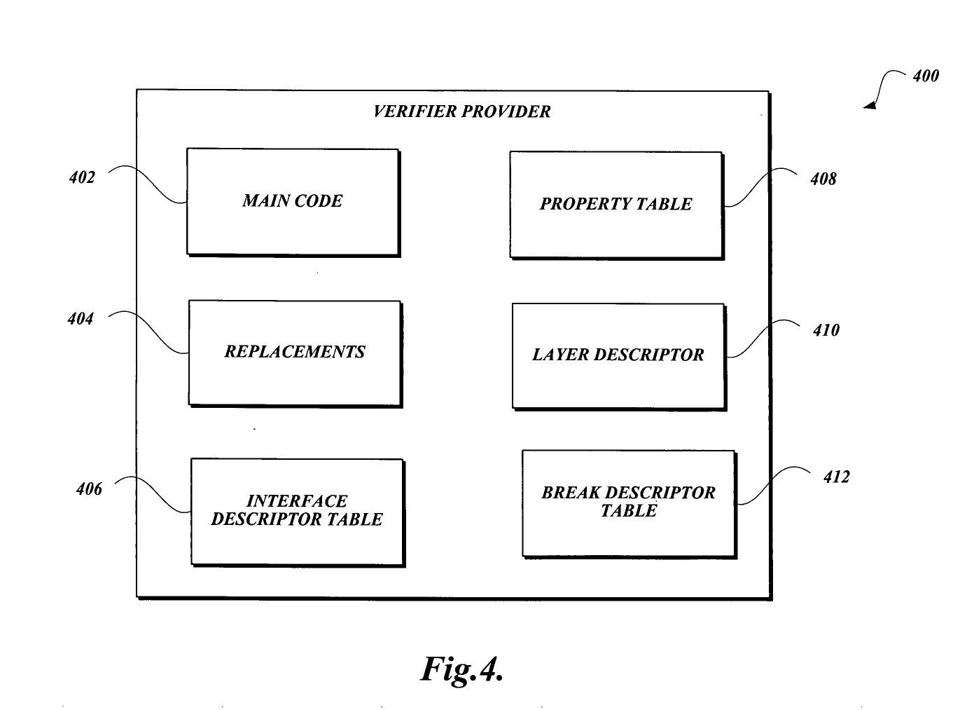

With reference to FIG. 4, a block diagram of a verifier provider 400 in accordance with an embodiment of the present invention will be described. The verifier provider 400 defines the verification for checks (tests) to predict how well an application will perform under a certain runtime setting. In one embodiment, the verifier provider 400 defines a verifier layer by providing a DLL comprising main code 402, replacements 404 that are replacement interfaces (e.g., API replacement functions) to be hooked. The verifier provider 400 further provides interface descriptor tables 406 that describe what is to be hooked, a property table 408 for the verification layer settings, and a break descriptors table 412 describing the possible verification events. Additionally the verifier provider 400 provides a simple protocol, such as a layer descriptor 410, which the verifier layer uses to declare to the engine module 104 and the core module 106 what interfaces are verified, and a simple protocol to advertise to the core module the layer descriptor 410, the related property table 408 and the break descriptor table 412.

In an illustrative embodiment, the verifier provider 400 can define any suitable verifier layers to be injected into the verifier infrastructure. For example, the verifier provider 400 may define a verifier layer that is configured to perform the verification for checks to determine memory corruptions issued in a heap allocation, to ensure the correct use of critical sections, Thread Lock Storage (TLS) APIs, and the like. The verifier provider 400 may define a verifier layer to perform the verification for checks to ensure that the application is not attempting to use invalid handles, or that returned thread in a thread pool is in a safe condition of reuse. In operation, the verifier layer includes various replacements 404 with which the engine module 104 hooks (replaces or redirects) system interfaces in order to track various objects or verify correctness of operations. For example, the replacements 404 may be used to track dangerous API to check if the application is using unsafe APIs, or to ensure that the application does not hide an access violation using structured exception handling. Similarly, the replacements 404 may be used to ensure that APIs for virtual space manipulation are correctly used in the application. Other examples of replacements 404 may include replacements for ensuring a proper user privilege by tracking LUA and a proper security check. One of ordinary skill in the art will appreciate that the verifier provider 400 is application environment independent. Further, any number of verifier providers can be added on to the verifier infrastructure, defining various verifier layers. One verifier provider may define one or more verifier layers. In one embodiment, the front engine module 108 discovers new verifier providers. As described above, the information relating to the verifier providers may be exposed through a set of normalized interfaces between various components in the computing system 100. In this embodiment, the front engine module 108 may provide a user interface to advertise the information relating to verifier layers, such as a set of configurable properties and a set of verification events, and to allow the user to configure desired verifier layers, a set of configurable properties of the configured verifier layers, and the like.

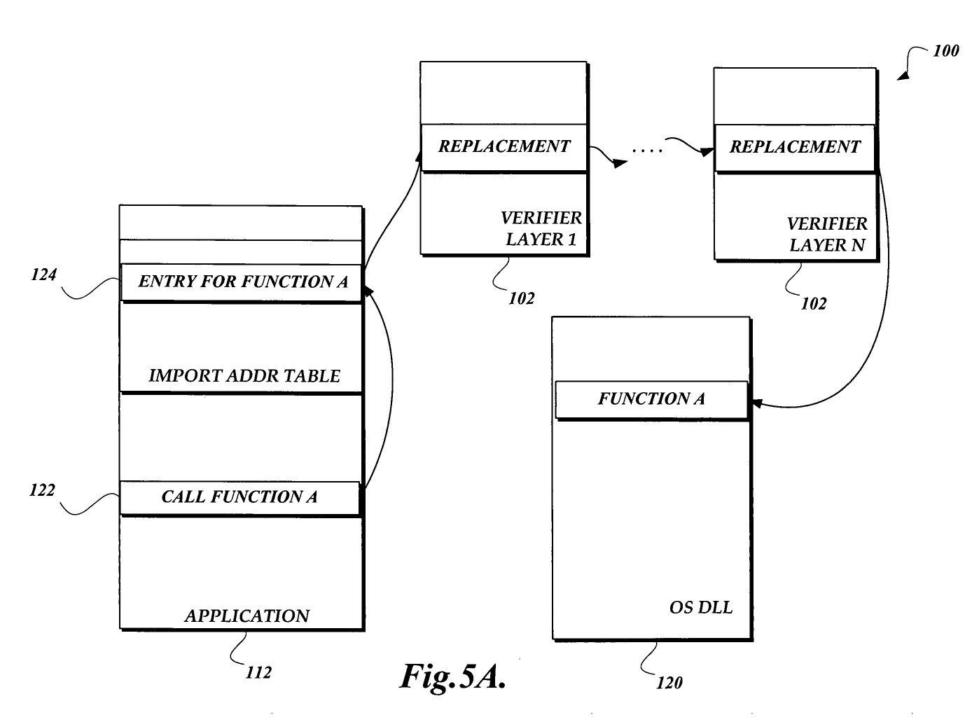

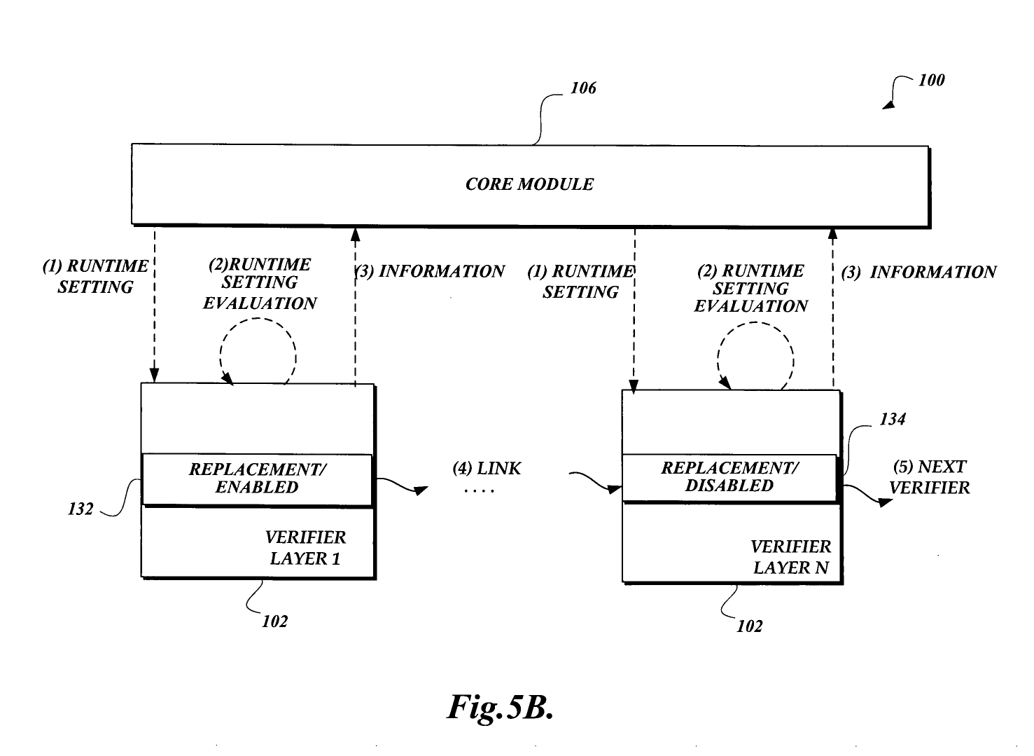

With reference to FIGS. 5A and 5B, block diagrams 500 of the computer system 100 illustrating the verifier layers 102 associated with an application 112 for verification are shown. As described above, there are various ways to perform API hooking. For example, API hooking may be performed by making direct modifications to the Import/Export Tables of the process (runtime application) and all its modules. In accordance with this embodiment, each process and module has its own IAT that contains the entry-point addresses of the APIs that are used. Such entry point addresses will be used when the process makes a call to the corresponding APIs. Therefore, by replacing the entry-point address of an API (in the IAT) with that of a replacement function, it is possible to redirect any calls to the API to the replacement function. It is to be noted that IAT modification is described as an example. It is contemplated that any suitable API hooking method can be used to intercept API calls.

With reference to FIG. 5A, the entry-point address of FUNCTION A 124 in an IAT has been modified so that when the application calls FUNCTION A 122, a proper replacement function can be executed. In an embodiment, several replacement functions may be executed in a desired order for API hooking. In such a case, each verifier layer that contains a replacement function for FUNCTION A may be linked in a desired hierarchy. With reference with FIG. 5B, after the application 112 and the verifier layers 102 are associated, the core module 106 may monitor for a runtime setting while the application 112 is running. Upon reception of the runtime setting, the core module 106 transmits the runtime setting to each verifier layer 102.

In accordance with an illustrative embodiment, each verifier layer 102 dynamically evaluates the runtime setting to determine whether to execute its corresponding verification code. Upon evaluation, each of the verifier layers 102 enables or disables its corresponding verification code (i.e., replacement functions). For example, replacement function 132 in verifier layer 1 is enabled and replacement function 134 in verifier layer N is disabled after the runtime setting evaluation. In this manner, the runtime setting is used to verify the desired checks by executing replacement function 132 but not replacement function 134. In one embodiment, the core module 106 transmits the runtime settings to a particular verifier layer in order to change one of its runtime configurable properties. In this case, the replacement function is always executed, but its specific behavior is changed. For example, replacement function for a memory allocation API can change the rate of injected failures. After the execution, information regarding execution of the replacement function 132 is gathered and provided to the core module 106.

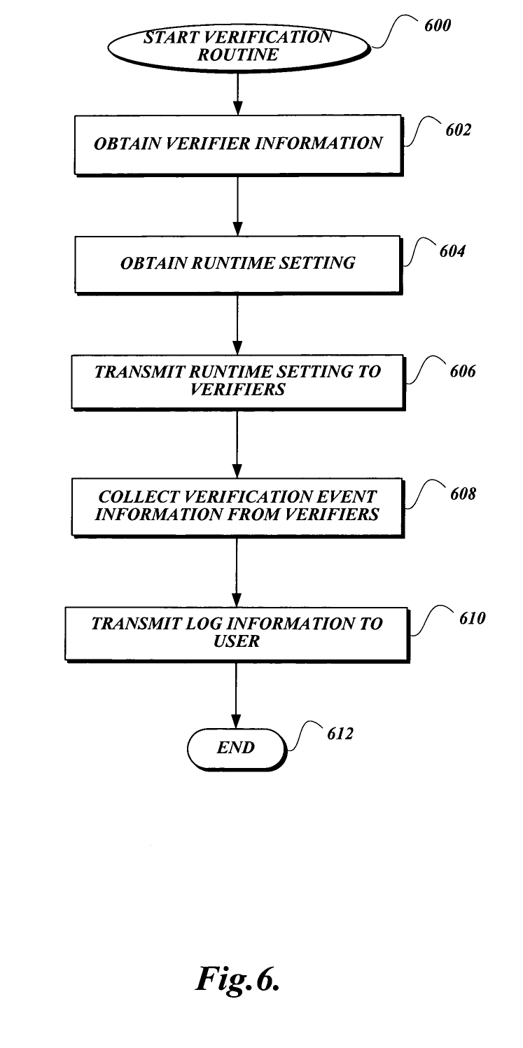

With reference new to FIG. 6, a flow diagram of verification routine 600 utilizing a verifier infrastructure in accordance with an embodiment of the present invention is shown. Beginning at block 602, the core module 106 obtains verifier information from verifier layers 102. As will be described in greater detail, the verifier layers 102 register their callback functions with the core module 106 so that core module 106 can pass information to the verifier layers 102. Further, the engine module 104 obtains verifier information from the verifier layers 102 to prepare a desired API hooking. In an embodiment, the verifier information includes a descriptor of the corresponding verifier layer, call back information and the like. The descriptors of the verifier layer may be used to advertise the verification to users. In one embodiment, the core module obtains a set of configuration changes for the behavior and/or action taken when a verification event occurs. The core module sends out log instructions to the verifier layers. The log instructions describe which verification event information to be collected at the verifier layers.

At block 604, the core module 106 obtains desired runtime settings associated with a processor (a runtime application) on a computer system. As described above, the desired runtime settings may include a runtime setting to ensure that the application does not hide access violation caused by use of exception handling, that the application properly manages virtual memory space, and the like. The desired runtime settings further include a runtime setting to track unsafe use of API. In some instances, the desired runtime setting includes a runtime setting to create a failure in order to test the behavior of the processor at the time of the failure. Further, the desired runtime settings include a runtime setting to simulate a low resource condition, such as being low on a class of resources and the like, in the computer system 100.

At block 606, the core module 106 transmits the runtime settings to the verifier layers 102. In an embodiment of the present invention, each registered callback function may be used to transmit the runtime settings. At block 608, the core module 106 collects verification event information from the verifier layers 102. As will be described in greater detail, each of the verifier layers 102 obtains the configuration information regarding the execution of its corresponding verification code, such as information regarding the behaviors of the replacement functions and the verification events. Based on the configuration information of the verification events, the verifier layers 102 gather information regarding the execution of the enabled verification code and provide the verification event information to the core module. The core module 106 then processes the verification event information, applies normalized processing (such as collection of context information and stack traces). The core module 106 generates and transmits the log information to users at block 610. In one embodiment, the log information is contained in a file format, such as XML format, suitable for being used in each user's display device. The verification routine 600 terminates at block 612.

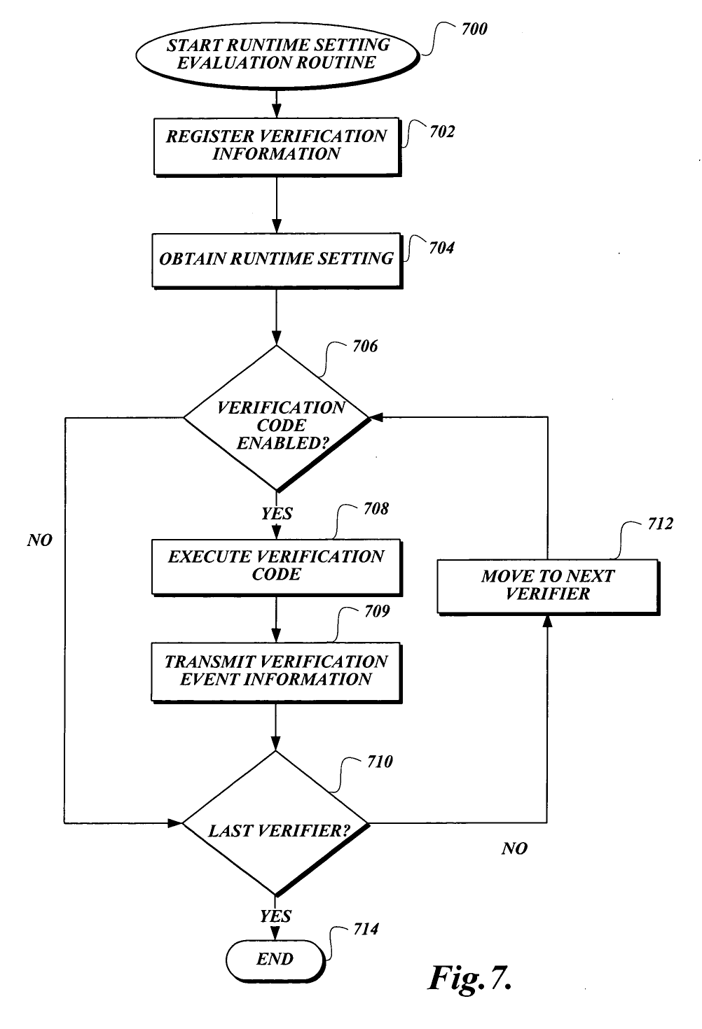

With reference to FIG. 7, a flow diagram of runtime setting evaluation routine 700 utilizing a verifier infrastructure in accordance with an embodiment of the present invention is shown. Beginning at block 702, each of the verifier layers 102 transmits its corresponding verification information to managing modules such as the core module 106 and the engine module 104. At block 704, the verifier layers 102 obtain a runtime setting and then evaluate the obtained runtime setting. Upon evaluation, each of the verifier layers 102 updates its corresponding verification code based on the runtime setting. As a result of the update, the verification code may be enabled or disabled in order to perform a desired API hooking under the runtime setting or the runtime behavior may be altered while keeping the API hooking enabled. For example, when zero-verification (no API to be intercepted) is desired, each verifier layer will disable its corresponding verification code. In this manner, no verification will be performed. As described above, the engine module 104 may inject each of the verifier layers 102 in a certain hierarchy at the time of deployment. It is to be noted that while runtime setting evaluation routine 700 in FIG. 7 describes several verifier layers 102 in a certain hierarchy, one of ordinary skill in the art will understand that there will be no hierarchy of verifier layers 102 when a single verifier layer is used to provide verification code for a desired test.

While the application 112 is running, a verifier layer examines whether its corresponding verification code is enabled with respect to the runtime setting at decision block 706. If the answer is no, indicating the corresponding verification code is disabled, the routine proceeds to decision block 710. If the answer is yes indicating that the corresponding verification code is enabled with respect to the runtime setting, the enabled verification code is executed to replace the API call in the application 112 at block 708. In an illustrative embodiment of the present invention, the core module 106 obtains a range of desired action and settings for the verification events as verification event configuration selected by a user. The core module 106 sends log instructions to the verifier layers for instructing which verification event information should be collected. Based on the log instructions, the verifier layer collects verification event information regarding the execution of the enabled verification code. The verifier layer transmits the collected verification event information to the core module 106 at block 709. The runtime setting evaluation routine 700 proceeds to decision block 710 to determine whether the verifier layer is the last verifier layer in the hierarchy. If the answer is no, the runtime setting evaluation routine 700 continues to block 712 where the next verifier layer is selected. The runtime setting evaluation routine 700 repeats the previously discussed processing steps. If the answer is yes, the runtime setting evaluation routine 700 terminates at block 714.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for collecting information regarding execution of an application, the method comprising:
obtaining verifier information from at least one verifier layer;
obtaining at least one runtime setting associated with the execution of a software application on a computer system;
transmitting the at least one runtime setting to the at least one verifier layer;
collecting verification event information from the at least one verifier layer;
processing the collected verification event information; and
wherein the verifier information includes a verifier descriptor, a set of interfaces, and a set of configurable properties and the at least one runtime setting corresponds to the set of configurable properties of the at least one verifier layer.

2. The method of claim 1 further comprising:
advertising the obtained verifier information to the user.

3. The method of claim 1, wherein processing the collected verification event information includes generating and transmitting log information to a user.

4. The method of claim 1, wherein the at least one runtime setting is used to verify use of exception handlings in the computer.

5. The method of claim 1, wherein the at least one runtime setting is used to verify unsafe use of Application Programming Interfaces in the computer.

6. The method of claim 1, wherein the at least one runtime setting is used to verify virtual memory management in the computer.

7. A method of providing information regarding execution of an application, the method comprising:
transmitting verification information to a managing module;
obtaining a runtime setting from the managing module;
evaluating the runtime setting to determine whether to execute verification code;
upon evaluation of the runtime setting, updating the verification code and configurable properties; and
transmitting the verification event information regarding the execution of the enabled verification code to the managing module.

8. The method of claim 7, wherein updating verification code includes enabling the verification code and disabling the verification code based on the evaluation of the runtime setting.

9. The method of claim 8 further comprising executing the enabled verification code while the application is running.

10. The method of claim 7 further comprising obtaining at least one instruction for which verification event information is collected.

11. The method of claim 7, wherein the test command includes a runtime setting being used to change behaviors of at least one of the Application Programming Interfaces called by the application.

12. A computer-readable medium having computer-executable components for creating an infrastructure to build and deploy runtime verifications, the computer-readable medium comprising:
at least one verifier layer component for providing verification code, the at least one verifier layer being defined in a verifier provider;
a core module component for managing the at least one verifier layer component, collecting verification event information from the at least one verifier layer component, and processing the verification event information;
a front module component for providing a user interface to receive a test configuration from a user and to display information provided by the core module;
wherein the core module component passes runtime settings to the at least one verifier layer component based on the set of configurable properties; and
wherein the at least one verifier layer component dynamically evaluates the received runtime settings to determine whether to execute verification code associated with the at least one verifier layer component in accordance with the runtime settings.

13. The computer-readable medium as described in claim 12, wherein the test configuration includes a configuration relating to a desirable verifier layer component and a set of configurable properties corresponding to the desirable verifier layer component.

14. The computer-readable medium as described in claim 13, wherein the core module component causes the application to execute after the at least one verifier layer component dynamically evaluates the runtime setting.

15. The computer-readable medium as described in claim 14, wherein at least one verifier layer transmits verification event information regarding execution of an application to the core module component.

16. The computer-readable medium as described in claim 15, wherein the core module component generates log information based on the processed verification event information and displays the log information via the user interface.

17. The method of claim 12, wherein the log information includes stack trace information.

18. The computer-readable medium as described in claim 12 further comprising:
a plurality of verifier layer components, wherein the verification code of each verifier layer component is configured to be executed in a desired order.

19. The computer-readable medium as described in claim 18, wherein the plurality of verifier layer components advertises verifier information to the core module; and
wherein the verification information includes a verifier descriptor, a set of interfaces, and a set of configurable properties corresponding to each verifier layer component.

20. The computer-readable medium as described in claim 19, wherein the core module component advertises the verifier information to users via the user interface.
